(19) United States
(12) Patent Application Publication
(10) Pub. No.: US 2015/0362119 A1
(43) Pub. Date: Dec. 17, 2015

(54) FACED INSULATION PRODUCTS HAVING AN ASPHALT ADHESIVE

(71) Applicant: Owens Corning Intellectual Capital, LLC, Toledo, OH (US)

(72) Inventors: Jerry Michael Parks, Danville, OH (US); Jacob T. Chacko, Pickerington, OH (US)

(21) Appl. No.: 14/732,850

(22) Filed: Jun. 8, 2015

Related U.S. Application Data
(60) Provisional application No. 62/010,499, filed on Jun. 11, 2014.

(51) Int. Cl. F16L 59/02; B32B 37/06; B32B 37/12

(52) U.S. Cl. CPC F16L 59/029; B32B 37/12; B32B 37/06; B32B 2309/02; B32B 2305/72; B32B 2037/1215

(57) ABSTRACT

A composition and method for making a faced insulation product having an asphalt adhesive layer is provided. The faced insulation product includes a facing layer laminated to a fibrous insulation layer by a waterless asphalt adhesive.

### RELATED APPLICATIONS

This application claims the benefit of U.S. provisional application No. 62/010,499 filed on Jun. 11, 2014, titled “FACED INSULATION PRODUCTS HAVING AN ASPHALT ADHESIVE” which is incorporated herein by reference in its entirety.

### FIELD OF THE DISCLOSURE

The present disclosure relates to a composition and method for making a faced insulation product. Particularly, the present disclosure relates to an insulation product having a facing layer laminated to a fibrous insulation layer by a waterless asphalt adhesive.

### BACKGROUND

Ducts and conduits are used to convey air in building heating, ventilation, and air conditioning (HVAC) systems. Often these ducts are formed of sheet metal, and as a result do not possess good thermal or acoustical properties. In order to enhance these properties, ducts may be provided with a flexible or rigid thermal and sound insulating material. In some applications, flexible wraps containing fibrous insulation materials (e.g., fiberglass) are wrapped around the exterior surfaces of a duct. In other applications, flexible fibrous insulation liners are applied to the internal surfaces of a duct (e.g., a cylindrical spiral metal duct). In still other applications, rigid insulating duct boards may be sized (e.g., cut or pre-formed) to be secured to internal or external surfaces of a square, rectangular, or spiral duct.

Duct insulation used in HVAC systems typically includes a facing layer adhered to an insulation layer. Often the facing layer acts as, or is, a vapor barrier. The fibrous duct insulation is typically formed of a suitable organic or inorganic material such as fiberglass. The facing material is commonly affixed to the fibrous insulation layer by an adhesive. Although there are numerous types of adhesives known in the art, water-based adhesives are most typically utilized to adhere the facing layer to the fibrous insulation.

### SUMMARY

Various exemplary embodiments of the present invention are directed to a composition and method for making faced insulation products. The composition and method disclosed herein includes an insulation product having a facing layer laminated to a fibrous insulation layer by a waterless asphalt adhesive.

In accordance with some exemplary embodiments, a faced insulation product is disclosed. The faced insulation product includes a first facing layer, an asphalt adhesive layer, and an insulation layer, wherein the asphalt adhesive layer secures the first facing layer to the insulation layer.

In accordance with some exemplary embodiments, a method of manufacturing a faced insulation product is disclosed. The method includes heating an asphalt adhesive to a molten state, applying the asphalt adhesive to a major surface of a first facing material, and adhering the first facing material to a fibrous insulation layer. The asphalt adhesive may secure the first facing material to the fibrous insulation layer. The method may further include rolling the faced insulation product into a final packaging form.

In accordance with some exemplary embodiments, an insulation wrap product is disclosed. The insulation wrap product includes a facing layer, an asphalt adhesive layer, and a fibrous insulation layer, wherein the asphalt adhesive layer laminates the facing layer to the fibrous insulation layer.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of a facing layer secured to an insulation layer by an asphalt adhesive of the present invention;

FIG. 2 is a schematic illustration of a fibrous insulation product used as a duct wrap according to at least one exemplary embodiment of the present invention; and

FIG. 3 is a perspective view of a duct board according to at least one exemplary embodiment of the present invention.

### DETAILED DESCRIPTION OF THE DISCLOSURE

A composition and method for making a faced insulation product is described in detail herein. The insulation product includes a facing layer laminated to a fibrous insulation layer by a waterless asphalt adhesive. These and other features of the faced insulation composition and method, as well as some of the many optional variations and additions, are described in detail hereafter.

Numerical ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present disclosure shall include the corresponding plural characteristic or limitation, and vice versa, unless otherwise specified or clearly implied to the contrary by the context in which the reference is made.

Exemplary faced insulation products are disclosed in U.S. Patent Application Publication Pub. No. 2010/0000170, U.S. Patent Application Publication Pub. No. 2013/0291990, and U.S. Patent Application Publication Pub. No. 2013/0295303. U.S. Patent Application Publications Pub. No. 2010/0000170, Pub. No. 2013/0291990, and Pub. No. 2013/0295303 are each incorporated herein by reference in their entirety. Faced insulation products in accordance with this present invention may include any combination or sub combination of the features disclosed by the present application and any of the three foregoing applications.

The general inventive concepts herein relate to a composition and method for making a faced insulation product having an asphalt adhesive layer. In accordance with some exemplary embodiments, a facing layer is laminated to a fibrous insulation layer by an asphalt adhesive. In some exemplary embodiments, the asphalt adhesive layer is substantially free of water. As discussed in detail hereafter, the asphalt adhesive reduces odor potential, improves fiberglass recovery and thickness, improves acoustic insulation properties, improves visual characteristics by limiting imperfections or “wrinkles,” and reduces manufacturing costs.

In some exemplary embodiments, the insulation products include at least one facing layer. The terms “facing layer” and “facing material” may be used interchangeably herein. The facing material is not particularly limited, and may be any facing material that is suitable for a fibrous insulation product.

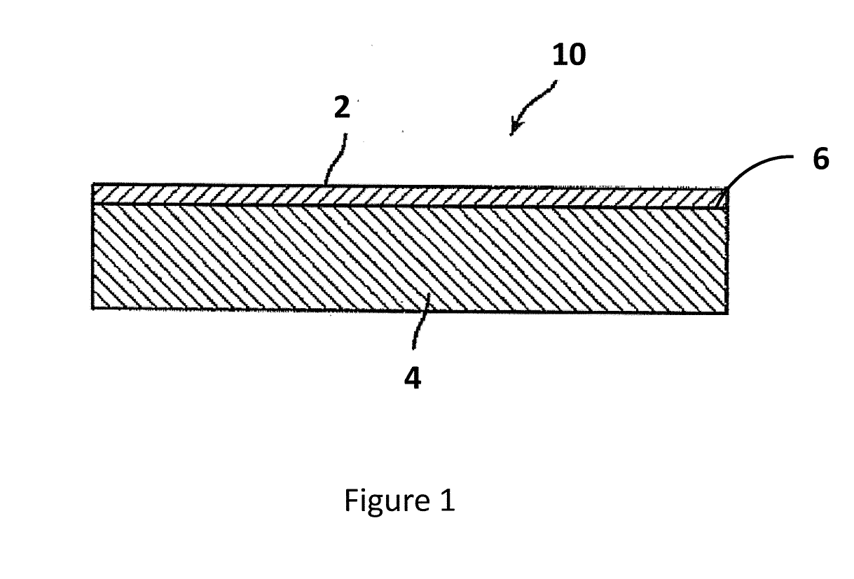

As shown in FIG. 1, to form the fibrous insulation product 10, the facing material 2 may be secured to a insulation layer 4 by an asphalt adhesive 6. The facing material 2 may include any of a foil, paper, woven, nonwoven, veil, mat, or glass scrim. In some exemplary embodiments, the facing material is a vapor barrier. In some exemplary embodiments, the facing material is a foil reinforced Kraft (FRK). In some exemplary embodiments, the facing material is a Polymer-Scrim-Kraft (PSK). In some exemplary embodiments, the facing material is formed from one or more of glass fibers, carbon fibers, mineral fibers, ceramic fibers, natural fibers, or synthetic fibers. The glass fibers may be made from any type of glass. Non-limiting examples of glass fibers include A-type glass fibers, C-type glass fibers, E-type glass fibers, S-type glass fibers, ECR-type glass fibers (e.g., Advantex® glass fibers commercially available from Owens Corning), Hiper-tex™ glass fibers, wool glass fibers, and combinations thereof. The term “natural fiber” as used in conjunction with the present invention refers to plant fibers extracted from any part of a plant, including, but not limited to, the stem, seeds, leaves, roots, or phloem. Examples of natural fibers which may be suitable for use as the facing material include basalt, cotton, jute, bamboo, ramie, bagasse, hemp, coir, linen, kenaf, sisal, flax, henequen, and combinations thereof. The term “synthetic fiber” as used herein is meant to indicate any man-made fiber having suitable reinforcing characteristics, such as polyester, polyethylene, polyethylene terephthalate, polypropylene, polyamide, aramid, and polyaramid fibers, as well as combinations thereof. Continuous fibers or multi-component fibers such as bicomponent or tricomponent polymer fibers may also be utilized in forming the facing layer. The bicomponent fibers may be formed in a sheath-core arrangement in which the sheath is formed of first polymer fibers that substantially surround a core formed of second polymer fibers.

In some exemplary embodiments, the facing material 2 is a glass nonwoven web formed by conventional dry-laid processes. In other embodiments, materials such as point boded, woven, and other nonwoven materials such as needled, spunbonded, or meltblown webs may be used. In some exemplary embodiments, a binder, flame-retardant, pigment, or other conventional additive may also be included in the facing. In some exemplary embodiments, the web facing material may be treated with a fungicide or bactericide either during or after manufacturing.

In some exemplary embodiments, an asphalt adhesive 6 laminates the facing layer 2 to a fibrous insulation layer 4. In some exemplary embodiments, the asphalt adhesive 6 is a blown asphalt, which aids in the reduction of odors. The term “blown” asphalt as used herein describes an asphalt that has undergone an oxidation process. The oxidation process involves blowing air through molten asphalt to modify the physical properties of the asphalt. In such an air blowing process, air is blown through an asphalt flux for a particular period of time at an elevated temperature.

In some exemplary embodiments, the asphalt adhesive 6 may be applied to the facing material via the application of heat. For example, in some exemplary embodiments the asphalt adhesive may heated to a softened, molten state and applied to a major surface of the facing material via roll coating. In some exemplary embodiments, the asphalt is heated to a temperature of about 200° F. to about 425° F., preferably a temperature of about 300° F. to about 425° F. In some exemplary embodiments, the asphalt is heated to a temperature of about 340° F. to about 360° F. In some exemplary embodiments, the asphalt is heated to a temperature of about 350° F. to about 375° F. In some exemplary embodiments, the asphalt adhesive is applied in a layer from about 2 to about 4 grams per square foot. In some exemplary embodiments, the asphalt adhesive may be applied in a layer from about 2 up to about 200 grams per square foot.

In some exemplary embodiments, the asphalt adhesive 6 may include one or more additives. In some exemplary embodiments, the additive may include one or more of flame retardants, fillers, odor masking agents, aroma, pigments, colorants, anti-microbial agents, biocides, cross linking agents, or other conventional additives. In some exemplary embodiments, the asphalt adhesive includes about 5% to about 40% by weight of a flame retardant, about 15% to about 30 percent by weight of a flame retardant, or about 15% to about 25% by weight of a flame retardant. In some exemplary embodiments, the flame retardant in the asphalt adhesive is colemanite. In some embodiments, the asphalt adhesive may include, but is not limited to, calcium carbonate, carbon black, zinc oxide, aluminum oxide, clays, chalk, calcium silicate, barium sulfate, or talc as fillers.

In some exemplary embodiments, the asphalt adhesive 6 may be substantially free of water. As used herein, the term “substantially free of water” implies that the asphalt adhesive may include a trace amount of water carried in the one or more possible additives (i.e. fillers, flame retardant, etc).

In some exemplary embodiments, an insulation layer 4 is adhered to the asphalt-coated facing layer to form a faced insulation product. It is to be appreciated that although glass fiber insulation is discussed herein, the fibrous insulation layer may be made from a wide variety of different materials. Exemplary fibrous insulation layer materials include, but are not limited to, nonwoven fiberglass and polymeric media, woven fiberglass and polymeric media, foam, including plastic foam and rubber foam, honeycomb composites, mineral wool, rock wool, ceramic fibers, glass fibers, aerogels, vermiculite, calcium silicate, fiberglass matrix, polymeric fibers, organic fibers, synthetic fibers, natural fibers, composite pre-forms, cellulose, wood, cloth, fabric, plastic, and cork. As used herein, the term “natural fiber” is meant to indicate plant fibers extracted from any part of a plant, including, but not limited to, the stein, seeds, leaves, roots, or blast. As used herein, the term “organic fibers” may include fibers made from rayon, polyethylene, polypropylene, nylon, polyester, and mixtures thereof. Continuous fibers or multi-component fibers such as bicomponent or tricomponent polymer fibers may also be utilized in forming the insulation layer. The bicomponent fibers may be formed in a sheath-core arrangement in which the sheath is formed of first polymer fibers that substantially surround a core formed of second polymer fibers. In some exemplary embodiments, the insulation layer may be a nonwoven web formed by conventional dry-laid processes. In other embodiments, materials such as point boded, woven, and other nonwoven materials such as needled, spunbonded, or meltblown webs may be used. In some exemplary embodiments, the insulation layer may be a nonwoven insulation layer formed by an air-laid process using premade fibers of glass, other minerals, or polymers that are scattered into a random orientation and optionally contacted with binder to form the product. The insulation layer can be made from any material that provides the thermal or acoustical insulation properties required by the application.

In some exemplary embodiments, the insulation layer 4 may be fire resistant, may include an antimicrobial material, and may include recycled material (e.g., made from over 55% recycled material). In some exemplary embodiments, a binder, flame-retardant, pigment, or other conventional additive may also be included in the insulation layer. In certain embodiments, the insulation may be treated with a fungicide or bactericide either during or after manufacturing.

In some exemplary embodiments, the insulation layer 4 is formed using glass fibers. The glass fibers may be matted glass fibers that are bonded together by a cured thermoset or thermoplastic polymeric material. The manufacture of glass fiber insulation products may be carried out in a continuous process by fiberizing molten glass and immediately forming a fibrous glass batt on a moving conveyor. The glass may be melted in a tank and supplied to a fiber forming device, such as a fiberizing spinner.

In some exemplary embodiments, the glass fibers are sprayed with an aqueous binder composition. Although any conventional binder such as phenol-formaldehyde and urea-formaldehyde may be used, the binder is desirably a low formaldehyde, or formaldehyde free, binder composition. Exemplary binder compositions include a polycarboxylic-based binder, a polyacrylic acid glycerol (PAG) binder, a polyacrylic acid triethanolamine (PAT) binder, and a bio-based binder. Exemplary bio-based binder compositions include at least one carbohydrate. The carbohydrate may be derived from plant sources such as legumes, maize, corn, waxy corn, sugar cane, milo, white milo, potatoes, sweet potatoes, tapioca, rice, waxy rice, peas, sago, wheat, oat, barley, rye, amaranth, and/or cassava, as well as other plants that have a high starch content. The carbohydrate polymer may also be derived from crude starch-containing products derived from plants that contain residues of proteins, polypeptides, lipids, and low molecular weight carbohydrates. The carbohydrate may be selected from monosaccharides (e.g., xylose, glucose, and fructose), disaccharides (e.g., sucrose, maltose, and lactose), oligosaccharides (e.g., glucose syrup and fructose syrup), polysaccharides and water-soluble polysaccharides (e.g., pectin, dextrin, maltodextrin, starch, modified starch, and starch derivatives). In some exemplary embodiments, the binder composition further includes one or more of a cross-linking agent, a catalyst, a coupling agent, a processing aid, an extender, a pH adjuster, a cross-linking density enhancer, a deodorant, an anti-oxidant, a dust suppressing agent, a biocide, a moisture resistant agent, and combinations thereof.

The binder may be present in an amount from about 2% to about 25% by weight of the total product, and preferably from about 5% to about 20% by weight of the total product, and most preferably from about 10% to about 18% by weight of the total product.

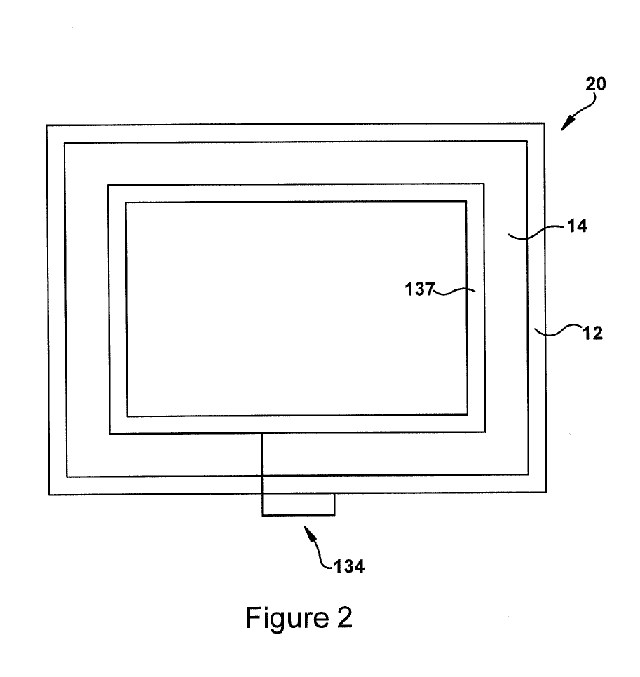

In some exemplary embodiments, the faced insulation products are utilized as a duct wrap to form a duct assembly as shown in FIG. 2. The duct assembly 20 may comprise a faced insulation product comprising an insulation layer 14 laminated to a facing layer 12 that is wider than the insulation layer along a transverse edge to form a flange 134. The faced insulation product may be wrapped around a sheet metal duct 137, with the edges of the duct wrap sealed by the sealing flange to form the duct assembly.

It is to be understood that the faced insulation products disclosed herein are not limited to duct wrap products. The faced insulation products may also be utilized in a number of applications, such as pipe insulation wrap. In some exemplary embodiments, the faced insulation product may be utilized as a duct liner. The duct liner may be folded into a shape substantially similar to the shape of the duct into which it is to be inserted, and inserted into a sheet metal to form a duct assembly. Both duct wrap and duct liner products enhance the thermal efficiency of duct work in a building and reduce noise associated with the movement of air through the duct.

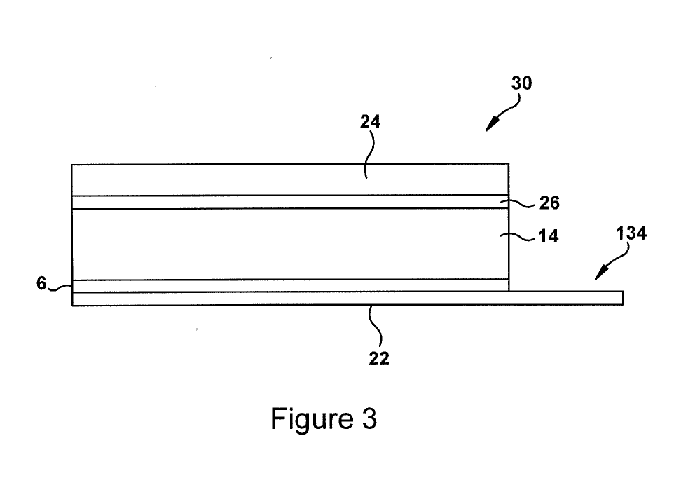

In some exemplary embodiments, facing materials are applied to both major surfaces of the fibrous insulation layer. As shown in FIG. 3, the fibrous insulation product may be a duct board 30 having facing materials adhered to opposing major surfaces of an insulation layer, a sealing flange 134, and optionally, male and female shiplap edges. The two facing materials may be formed of an outer surface layer 22, such as, but not limited to, a vapor barrier, and an inner surface layer 24 formed of a nonwoven fibrous web, veil, or mat. In some exemplary embodiments, a first facing layer 22 is a vapor barrier positioned on a first major surface of the fibrous insulation layer 14, and is affixed to the first major surface by an asphalt adhesive 6. A second facing layer 24 may be a fibrous web which is affixed to the second major surface of the fibrous insulation layer by the asphalt adhesive 26. The duct board may be formed into an air duct by folding the duct board into a generally rectangular shape, such that the second facing layer faces an interior portion thereof, and the first facing layer is positioned on an exterior surface of the air duct. It is to be appreciated that the duct board may be formed into a square shape, or a non-square shape such as a rectangular, round, or oval air duct, as would be understood by those of skill in the art.

The densities of the faced insulation products disclosed herein may vary widely depending on the product. Some exemplary faced insulation products in accordance with the present invention have a density from about 0.5 pcf to about 8 pcf. In some exemplary embodiments, a duct wrap product may have a density of about 0.75 pcf. In other exemplary embodiments, an insulation board product may have a density of about 8 pcf.

Whereas conventional adhesives used in faced insulation products are water-based and require a high amount of heat energy to flash off and evaporate the water during the curing of the adhesive, the use of an asphalt adhesive to secure a facing layer to an insulation layer reduces the time required for drying and curing the adhesive prior to roll-up. The asphalt adhesive further helps to reduce or eliminate wrinkles, as well as many other detrimental effects. The blown asphalt adhesive reduces odor potential, improves fiberglass recovery, improves acoustic insulation properties, and reduces manufacturing costs. Additionally, the asphalt adhesive exhibits a constant or nearly constant weight distribution across the facing.

A further benefit of a waterless adhesive includes the additional perm protection that asphalt provides if the foil or adjoining facing develops pinholes or other imperfections during or post manufacturing. In some instances, a facing or foil layer may exhibit holes from handling or installation errors. The asphalt adhesive disclosed herein may seep to fill or cover any such holes that develop in the facing layer.

### Examples

The properties of an exemplary faced insulation product are described below. In the exemplary embodiment, the physical properties of a duct wrap utilizing an asphalt adhesive were compared to the physical properties of a duct wrap utilizing a conventional water-based adhesive.

Table 1 summarizes the peel strength of an asphalt adhesive-faced wrap as compared to a water-based adhesive faced wrap. The peel strength test measures the pound force required to peel the facing layer away from the fully-cured faced insulation product. Table 1 shows the maximum pound force (“Max. Ld.”) and average pound force (“Ave. Ld.”) required to peel the facing layer away at a 90° angle from eight sample asphalt adhesive faced and water-based adhesive faced specimens.

TABLE 1
Peel Strength Tests

| Asphalt Adhesive Faced Wrap | | | Water-Based Adhesive Faced Wrap | | |
|---|---|---|---|---|---|
| | Max. Ld | Ave. Ld. | | Max. Ld | Ave. Ld. |
| | (lbf) | (lbf) | | (lbf) | (lbf) |
| 1 | 0.92550 | 0.72448 | 1 | 0.43331 | 0.33554 |
| 2 | 0.97022 | 0.68242 | 2 | 0.50632 | 0.39745 |
| 3 | 0.75794 | 0.66321 | 3 | 0.41303 | 0.32048 |
| 4 | 1.17518 | 0.93135 | 4 | 0.49814 | 0.39984 |
| 5 | 1.73196 | 1.40252 | 5 | 0.39847 | 0.30148 |
| 6 | 0.93869 | 0.61125 | 6 | 0.43837 | 0.34328 |
| 7 | 0.71001 | 0.59896 | 7 | 0.44808 | 0.33456 |
| 8 | 1.29691 | 1.11279 | 8 | 0.33536 | 0.28129 |
| Mean | 1.0633 | 0.84087 | Mean | 0.43389 | 0.33924 |
| Standard | 0.33283 | 0.28761 | Standard | 0.05476 | 0.04183 |
| Deviation | | | Deviation | | |

Tables 2 and 3 and summarize the recovery of an asphalt adhesive faced wrap as compared to a water-based adhesive faced wrap. Recovery was tested according to ASTM Std C167 test methods. The tests for recovery measure the thickness of each faced insulation wrap upon initial unrolling (Table 2), and again after manipulating the faced insulation wrap to mimic standard commercial use (Table 3).

Tables 2 (a) through (c) summarize the recovery tests on a sample of asphalt adhesive faced wrap as compared to a water-based adhesive faced wrap. Each faced insulation wrap was unrolled from its final packaged form, and thickness recovery was measured 15 minutes after unrolling at (a) beginning, (b) middle, and (c) core. As used herein, the preceding terms are based on relative locations along an unrolled insulation wrap blanket. For example, a packaged 4 foot wide by 2 foot diameter roll of duct wrap may measure 100 linear feet in length upon unrolling. The average thickness along this length is measured with a pin gauge tape measure at the (a) beginning of the roll, (b) middle of the roll (e.g., at 50 feet), and (c) core of the roll (e.g., at or near 100 feet).

TABLE 2a
Beginning Thickness Upon Unrolling

| | Water-Based Adhesive | Asphalt Adhesive |
|---|---|---|
| | Faced Wrap (inches) | Faced Wrap (inches) |
| 1 | 2.80 | 3.51 |
| 2 | 2.84 | 3.22 |
| 3 | 2.83 | 3.69 |
| 4 | 3.06 | 3.38 |
| 5 | 2.89 | 3.63 |
| 6 | 2.68 | 3.35 |
| 7 | 3.03 | 3.47 |
| 8 | 2.42 | 3.86 |
| 9 | 2.74 | 3.45 |
| 10 | 2.46 | 3.63 |
| 11 | 2.73 | 3.89 |
| 12 | 2.35 | 3.72 |
| 13 | 2.35 | 3.75 |
| 14 | 2.77 | 3.69 |
| 15 | 2.46 | 3.41 |
| Average | 2.69 | 3.58 |

TABLE 2b
Middle Thickness Upon Unrolling

| | Water-Based Adhesive | Asphalt Adhesive |
|---|---|---|
| | Faced Wrap (inches) | Faced Wrap (inches) |
| 1 | 2.76 | 3.36 |
| 2 | 1.80 | 3.05 |
| 3 | 2.17 | 3.46 |
| 4 | 2.76 | 3.27 |
| 5 | 2.33 | 3.22 |
| 6 | 2.12 | 3.05 |
| 7 | 2.39 | 3.37 |
| 8 | 2.26 | 3.28 |
| 9 | 2.39 | 2.96 |
| 10 | 2.11 | 2.92 |
| 11 | 2.32 | 3.07 |
| 12 | 2.33 | 3.19 |
| 13 | 2.19 | 2.98 |
| 14 | 2.35 | 3.21 |
| 15 | 2.33 | 3.79 |
| Average | 2.31 | 3.21 |

TABLE 2c
Core Thickness Upon Unrolling

| | Water-Based Adhesive | Asphalt Adhesive |
|---|---|---|
| | Faced Wrap (inches) | Faced Wrap (inches) |
| 1 | 2.78 | 3.61 |
| 2 | 2.12 | 3.42 |
| 3 | 2.63 | 3.78 |
| 4 | 3.10 | 3.62 |
| 5 | 2.40 | 3.07 |
| 6 | 2.11 | 3.17 |
| 7 | 2.46 | 3.19 |
| 8 | 2.77 | 3.29 |
| 9 | 2.19 | 3.24 |
| 10 | 2.21 | 2.80 |
| 11 | 2.73 | 3.14 |
| 12 | 2.67 | 3.47 |
| 13 | 2.10 | 3.30 |
| 14 | 2.13 | 3.33 |
| 15 | 2.78 | 3.26 |
| Average | 2.48 | 3.31 |

In the faced insulation wraps tested herein, the combined average thickness upon unrolling was 3.37 inches for the asphalt adhesive faced wrap, as compared to 2.49 inches for the water-based adhesive faced wrap.

Tables 3 (a) through (c) summarize the recovery tests on a sample of asphalt adhesive faced wrap as compared to a water-based adhesive faced wrap in circumstances mimicking standard commercial use. Each unrolled faced insulation wrap was folded upon itself and then opened back to its unrolled state to manipulate the insulation wrap product. After folding and unfolding each insulation wrap, the thickness was measured at the (a) beginning, (b) middle, and (c) core to evaluate the recovery of the asphalt adhesive faced wrap as compared to a water-based adhesive faced wrap.

TABLE 3a
Beginning Thickness Recovery

| | Water-Based Adhesive | Asphalt Adhesive |
|---|---|---|
| | Faced Wrap (inches) | Faced Wrap (inches) |
| 1 | 2.46 | 4.42 |
| 2 | 2.67 | 4.47 |
| 3 | 3.65 | 4.03 |
| 4 | 3.49 | 4.06 |
| 5 | 2.81 | 4.38 |
| 6 | 3.29 | 4.06 |
| 7 | 3.11 | 3.61 |
| 8 | 3.49 | 4.1 |
| 9 | 2.8 | 4.47 |
| 10 | 3 | 4.02 |
| 11 | 3.69 | 4.02 |
| 12 | 3.37 | 4.12 |
| 13 | 3.12 | 4.41 |
| 14 | 3.29 | 4.24 |
| 15 | 3.63 | 3.89 |
| Average | 3.19 | 4.15 |

TABLE 3b
Middle Thickness Recovery

| | Water-Based Adhesive | Asphalt Adhesive |
|---|---|---|
| | Faced Wrap (inches) | Faced Wrap (inches) |
| 1 | 3.29 | 4.19 |
| 2 | 2.27 | 4.17 |
| 3 | 2.32 | 3.87 |
| 4 | 2.76 | 3.46 |
| 5 | 2.88 | 4.09 |
| 6 | 3.03 | 3.98 |
| 7 | 2.9 | 3.6 |
| 8 | 2.61 | 3.89 |
| 9 | 2.76 | 3.87 |
| 10 | 3.42 | 3.98 |
| 11 | 2.9 | 3.82 |
| 12 | 2.54 | 3.91 |
| 13 | 3.37 | 4.06 |
| 14 | 3.18 | 4.1 |
| 15 | 2.4 | 3.74 |
| Average | 2.84 | 3.92 |

TABLE 3c
Core Thickness Recovery

| | Water-Based Adhesive | Asphalt Adhesive |
|---|---|---|
| | Faced Wrap (inches) | Faced Wrap (inches) |
| 1 | 3.43 | 4.27 |
| 2 | 3.21 | 3.96 |
| 3 | 3 | 3.6 |
| 4 | 3.21 | 3.84 |
| 5 | 3 | 4.37 |
| 6 | 3.06 | 4 |
| 7 | 3.01 | 3.57 |
| 8 | 2.79 | 3.5 |
| 9 | 3.21 | 4.02 |
| 10 | 3.29 | 3.98 |
| 11 | 2.63 | 3.6 |
| 12 | 2.6 | 3.58 |
| 13 | 3.27 | 4.37 |
| 14 | 2.96 | 4.02 |
| 15 | 2.71 | 3.71 |
| Average | 3.03 | 3.89 |

The combined average recovery thickness was 3.99 inches for the asphalt adhesive faced wrap, as compared to 3.02 inches for the water-based adhesive faced wrap.

As discussed in detail above, in some exemplary embodiments, the asphalt adhesive is a blown asphalt, which aids in the reduction of odors. An Odor Emission Measurement Test using heat was performed on a sample of asphalt adhesive faced insulation wrap at temperatures of 120° F., 140° F., and 160° F. As shown in Table 4, the asphalt adhesive faced insulation wrap received a “pass” designation in both internal and third-party Odor Emission Measurement Tests at each of the aforementioned temperatures, indicating that no odor was present on the faced insulation wrap. The third-party Odor Emission Measurement Test was conducted in accordance with the standards set forth in the ASTM C1304-08 “Test Method for Assessing the Odor Emission of Thermal Insulation Materials.”

TABLE 4
Internal Odor Emission Test
2 DAY CONDITIONING

| 120 F. | 140 F. | 160 F. |
|---|---|---|
| PASS | PASS | PASS |
| PASS | PASS | PASS |

COMMENTS: No smell at any of the temperatures

As used in the description of the invention and the appended claims, the singular forms “a,” “an,” and “the” are intended to include the plural forms as well, unless the context clearly indicates otherwise. To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

Unless otherwise indicated herein, all sub-embodiments and optional embodiments are respective sub-embodiments and optional embodiments to all embodiments described herein. While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative process, and illustrative examples shown and described. Accordingly, departures may be made from such details without departing from the spirit or scope of the applicant's general disclosure herein.

What is claimed is:

1. A faced insulation product comprising:
a first facing layer;
an asphalt adhesive layer; and
an insulation layer,
wherein the asphalt adhesive layer secures the first facing layer to the insulation layer.

2. The faced insulation product of claim 1, wherein the first facing layer comprises a vapor barrier.

3. The faced insulation product of claim 1, wherein the asphalt adhesive layer is substantially free of water.

4. The faced insulation product of claim 1, wherein the insulation layer comprises a blanket of glass fibers.

5. The faced insulation product of claim 1, wherein the asphalt adhesive layer further comprises from about 5% to about 40% by weight of a flame retardant.

6. The faced insulation product of claim 1, further comprising a second facing layer.

7. The faced insulation product of claim 1, wherein the first facing layer comprises a single sheet of material.

8. A method of manufacturing a faced insulation product, the method comprising:
heating an asphalt adhesive to a molten state;
applying the asphalt adhesive to a major surface of a first facing material; and
adhering the first facing material to a fibrous insulation layer, wherein the asphalt adhesive secures the first facing material to the fibrous insulation layer forming a faced insulation product.

9. The method of claim 8, further including the step of rolling the faced insulation product into a final packaging form.

10. The method of claim 8, wherein the first facing material comprises a vapor barrier.

11. The method of claim 8, wherein the asphalt adhesive is substantially free of water.

12. The method of claim 8, wherein the fibrous insulation layer comprises a blanket of glass fibers.

13. The method of claim 8, wherein the asphalt adhesive is substantially cured prior to the step of rolling the faced insulation product into a final packaging form.

14. The method of claim 8, further comprising:
applying the asphalt adhesive to a major surface of a second facing material; and
adhering the second facing material to the fibrous insulation layer, wherein the asphalt adhesive secures the second facing material to the fibrous insulation layer, and wherein the first facing material and the second facing material are adhered to opposing surfaces of the fibrous insulation layer.

15. The method of claim 8, wherein the asphalt adhesive is applied to the first facing material in a layer from about 2 to about 200 grams per square foot.

16. The method of claim 8, further comprising adding from about 5% to about 40% by weight of a flame retardant to the asphalt adhesive.

17. The method of claim 8, wherein the asphalt adhesive is heated to a temperature of about 200° F. to about 425° F.

18. A faced insulation product manufactured by the method of claim 8.

19. An insulation wrap product comprising:
a facing layer;
an asphalt adhesive layer; and
a fibrous insulation layer,
wherein the asphalt adhesive layer laminates the facing layer to the fibrous insulation layer.

20. The insulation wrap product of claim 19, wherein the insulation wrap product is wrapped around a sheet metal duct to form a duct assembly.

21. The insulation wrap product of claim 19, wherein the facing layer comprises a vapor barrier.

22. The insulation wrap product of claim 19, wherein the asphalt adhesive layer further comprises from about 5% to about 40% by weight of a flame retardant.
